(19) United States
(12) Patent Application Publication
(10) Pub. No.: US 2025/0370920 A1
(43) Pub. Date: Dec. 4, 2025

(54) Linking RAM Code and Data with Multiple RAM Aliases

(71) Applicant: Silicon Laboratories Inc., Austin, TX (US)

(72) Inventors: Jean Francois Deschenes, Ste-Marthe-sur-le-lac (CA); Christian Galante, LaSalle (CA)

(21) Appl. No.: 18/675,227

(22) Filed: May 28, 2024

(51) Int. Cl. G06F 12/02

(52) U.S. Cl. CPC G06F 12/023

(57) ABSTRACT

A system and method for allocating instructions and data in a common memory device that uses aliased addresses is disclosed. The linker uses a linker script that tracks the amount of space that is allocated in the common memory device. It then uses this information to properly adjust the starting addresses for the different address ranges to ensure that no information is overwritten or corrupted. This technique allows instructions to be disposed in the same memory device as other data, but be accessed using an aliased address. This is particularly beneficial for processing units that utilize different busses for instructions and data.

### FIELD

This disclosure describes systems and methods for linking RAM code and data when multiple address aliases are used.

### BACKGROUND

Many wireless protocols, such as Bluetooth Low Energy (BLE) and others, are enabling the Internet of Things (IOTs). Some aspects of these IOT devices are their compact design, low power consumption and high level of integration. Additionally, many of these devices are utilizing network protocols which have timing constraints, which require predictability and speed of code execution.

One technique to improve the predictability and speed of code execution is to place the time critical code in a random access memory (RAM) that allows higher speed accesses than are possible with nonvolatile memory devices. This RAM may therefore contain both instructions and data.

Additionally, certain processors utilize a Harvard architecture where there are separate buses for instructions and data. In these processors, the address space that is assigned for instructions is read only, while the address space that is assigned for data is both readable and writable.

Thus, the same physical memory device may contain both instructions and data, and therefore may have two different address spaces.

This situation affects the placement of instructions and data in the memory device, which, in turn, affects the operation of the linker.

Therefore, it would be beneficial if there was a system and method to create the software image for a device that utilizes a single physical RAM device to contain both instructions and data.

### SUMMARY

A system and method for allocating instructions and data in a common memory device that uses aliased addresses is disclosed. The linker uses a linker script that tracks the amount of space that is allocated in the common memory device. It then uses this information to properly adjust the starting addresses for the different address ranges to ensure that no information is overwritten or corrupted. This technique allows instructions to be disposed in the same memory device as other data, but be accessed using an aliased address. This is particularly beneficial for processing units that utilize different busses for instructions and data.

According to one embodiment, a method of creating an executable file using a linker script is disclosed. The method comprises assigning a first address range and a second address range to a same physical memory device; allocating a first portion of the physical memory device to the first address range for storage of content, starting at a first starting address; determining a size of the first portion, referred to as an offset; adding the offset to a starting address of the second address range to define a new second address of the second address range; and allocating data in the physical memory device to the second address range starting at the new second address of the second address range.

According to another embodiment, a method of creating an executable file using a linker script is disclosed. The method comprises assigning a first address range and a second address range to a same physical memory device; allocating a first portion of the physical memory device to the second address range for storage of a first portion of data, starting at a second starting address; determining a size of the first portion of data, referred to as a first offset; adding the first offset to a starting address of the first address range to define a new first address of the first address range; allocating a second portion of the physical memory device to the first address range for storage of content, starting at the new first address; determining a size of the content, referred to as a second offset; adding the second offset to an ending address of the first portion of data to define a new second address; and allocating a second portion of data to the second address range starting at the new second address of the second address range. In some embodiments, the content comprises instructions. In some embodiments, the linker script determines which functions are to be stored in the first portion of the physical memory device. In some embodiments, the first address range is designated as read only. In some embodiments, the second address range is designated as readable and writable.

According to another embodiment, a system is disclosed. The system comprises a processing unit; a nonvolatile memory device; and the physical memory device configured using any of the methods described above; wherein the processing unit uses the first address range to access instructions and the second address range to access data. In some embodiments, the first address range also includes the nonvolatile memory device. In some embodiments, the processing unit comprises separate buses for accessing instructions and data.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a wireless network device that may utilize the memory allocation scheme described herein;

FIG. 2 shows the layout of the data memory device according to one embodiment;

FIG. 3 shows the operation of the linker to create the memory layout shown in FIG. 2;

FIG. 4 shows the layout of the data memory device according to a second embodiment; and

FIG. 5 shows the operation of the linker to create the memory layout shown in FIG. 4.

### DETAILED DESCRIPTION

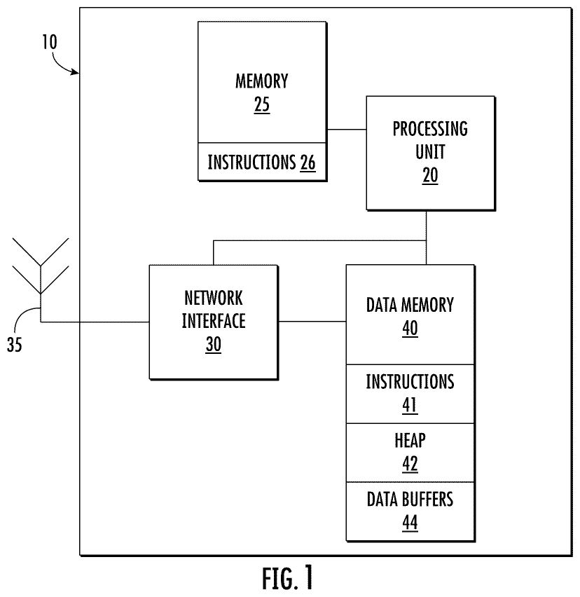

FIG. 1 shows a block diagram of a representative network device 10 that includes a single RAM device that contains both instructions and data.

The network device 10 has a processing unit 20 and an associated memory device 25. The processing unit 20 may be any suitable component, such as a microprocessor, embedded processor, an application specific circuit, a programmable circuit, a microcontroller, or another similar device. The processing unit 20 includes separate busses for instructions and data. In this way, the processing unit 20 is able to fetch instructions at the same time that it is reading or writing data to an external device. Further, the processing unit 20 differentiates between these two spaces based on the address used for the access. Specifically, a first address range may be assigned as instructions. All accesses to this first address range utilize the busses that are associated with instructions. Further, the first address range is typically defined as read only. A second address range, different from the first address range, is assigned as data. All accesses to this second address range utilize the busses that are associated with data. Further, the second address range is typically defined as readable and writable.

The memory device 25 contains the instructions 26, which, when executed by the processing unit 20, enable the network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. The address for the memory device 25 is within the first address range of the processing unit 20.

The memory device 25 may be any suitable computer readable medium that can be employed to store these instructions. For example, a read only memory (ROM), a FLASH ROM, an electrically erasable ROM, or another nonvolatile memory device may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CD ROM, or a different memory device, which is located remote from the network device 10. The instructions contained on this second computer readable non-transitory media may be downloaded onto the memory device 25 to allow execution of the instructions by the network device 10.

The network device 10 may also include a network interface 30, which may be a wireless interface that connects with an antenna 35. The network interface 30 may support any wireless network, such as Bluetooth, Wi-Fi, networks utilizing the IEEE 802.15.4 specification, such as Zigbee and Wi-SUN, networks utilizing the IEEE 802.15.6 specification, and wireless smart home protocols, such as Z-Wave. Further, the network interface 30 may also support a proprietary or custom wireless network. The network interface 30 includes a transmit circuit which is used to transmit data from this network device 10 using the antenna 35. The network interface 30 also includes a receive circuit which is used to receive packets.

The network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless network. Any data stored in the data memory device 40 may be accessed by the processing unit 20 using the second address range. Although not shown, the network device 10 also has a power supply, which may be a battery or a connection to a permanent power source, such as a wall outlet.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the network device 10, not its physical configuration. Further, while the above describes a network device, it is understood that this technique is applicable to any device that seeks to use two different address ranges to access a common memory device.

Additionally, as shown in FIG. 1, the data memory device 40 may be used to retain many types of information. For example, for speed of execution, some or all of the instructions 26 in the memory device 25 may be copied to the data memory device 40 and saved as instructions 41. Ideally, these instructions 41 are accessed by the processing unit 20 using the first address range.

Additionally, the data memory device 40 is also used to hold data buffers 44. These data buffers 44 may represent data that has been received from the network interface 30 or will be transmitted using the network interface 30.

Additionally, there is another section of the data memory device 40 that may be referred to as the heap 42. The heap 42 includes variables or areas that are utilized by the various software applications and modules that are executed by the processing unit 20. There may also be other types of information stored in the data memory device 40.

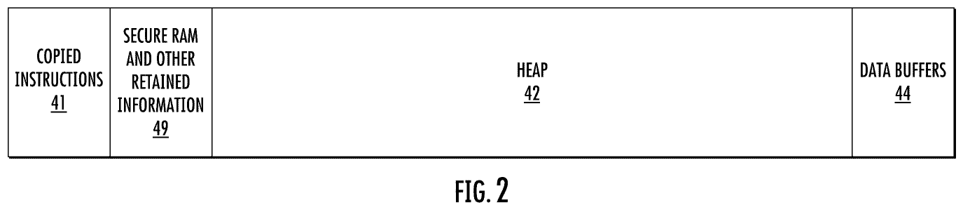

As described above, the data memory device 40 may also contain instructions 41, which may be disposed before the beginning of the heap 42. FIG. 2 shows the memory layout according to one embodiment.

To achieve the memory layout shown in FIG. 2, memory is allocated during a link time phase. The linker is used to designate certain regions of the volatile memory prior to execution of the software.

Additionally, there may be some secure RAM and other information 49 stored in the data memory device 40. In some embodiments, this information may be located at the starting address of the data memory device 40. In other embodiments, this information may be located at a different address. These regions of memory are allocated by the linker at link time. A linker is a utility software program that takes object files created by compilers and other input and generates a single executable file, often in the form of a .elf or .bin file.

Additionally, any instructions 41 that are copied to data memory device 40 may be located near the starting address of the data memory device 40, although other locations are also possible. The location of the instructions 41 is also determined by the linker at link time.

As noted above, the instructions 41, when executed by the processing unit 20, are within the first address range, while the other information (the heap 42, the secure RAM or other information 49 and the data buffers 44, collectively referred to as data) is within the second address range.

However, at initialization, the instructions 26 from the memory device 25 need to be written to the data memory device 40 to create instructions 41. However, as noted above, the first address range is read only. Therefore, to write instructions 41 to the data memory device 40, the processing unit 20 must use the second address range.

Thus, the instructions 41 occupy a portion of the first address range and also occupy a portion of the second address range. However, while two different address ranges are used to access the instructions 41, both addresses actually access the same physical memory. Thus, the address used by the processing unit 20 to access the instructions 41 using the first address range may be considered an aliased address.

However, this fact is not known to the linker. Therefore, special considerations are needed in order to have the linker correctly allocate the memory in the data memory device 40.

There are several ways that this may be accomplished. In each embodiment, the second address range may be assumed to start at the first physical address in the data memory device 40. In these examples, assume that the first address range starts at address 0x3000000 and the second address range starts at address 0x2000000. Note that these values are merely illustrative.

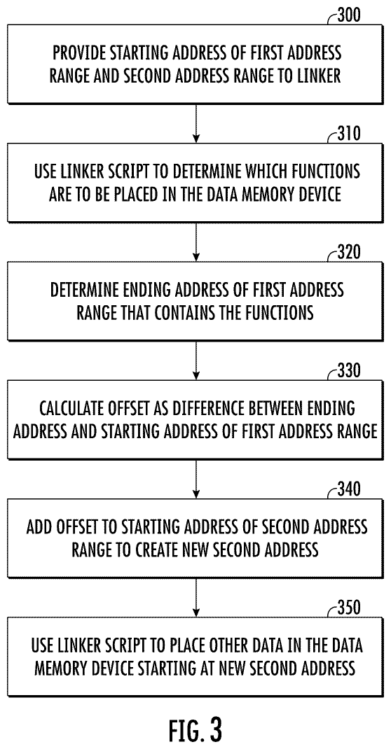

In one embodiment, the instructions 41 are disposed at the start of the first physical address in the data memory device 40. This embodiment is shown in the diagram shown in FIG. 2. The sequence performed by the linker is shown in FIG. 3.

First, as shown in Box 300, the linker is provided with the aliased address (0x3000000) and the non-aliased address (0x2000000) that each map to the start of the data memory device 40. These two addresses represent the starting address of the first address range and the second address range, respectively. Note that the instructions 41 are considered to be part of the first address range by the linker. The linker is able to determine the size of the instructions 41 based on how much space was used in the first address range. Specifically, as shown in Box 310, the linker uses a linker script to determine which functions are to be placed in the data memory device 40. This may be based on whether a particular function is time critical or may be based on other criteria. The linker script may be compatible with GCC (Gnu Compiler Collection) or other compilers. The linker script tracks the addresses that are assigned to the various functions that are being copied to the data memory device 40, which begins at 0x3000000. When all of the desired functions have been placed in the data memory device 40, the linker script then determines the ending address used for these functions as shown in Box 320. The original starting address (0x3000000) is then subtracted from this ending address as shown in Box 330. This represents the amount of storage that is consumed by the instructions 41 in the data memory device 40. The linker script then uses this value as an offset, which is added to the starting address of the second address range, as shown in Box 340. Thus, the linker will begin allocating space in the second address range starting at address 0x2000000+offset, as shown in Box 350. In this way, although the linker may believe that addresses 0x2000000 through 0x2000000+offset−1 are free, they are not used by the linker.

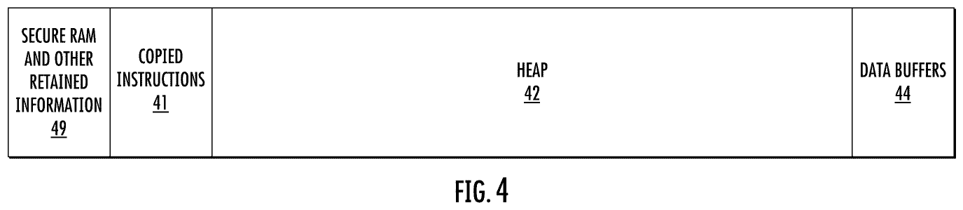

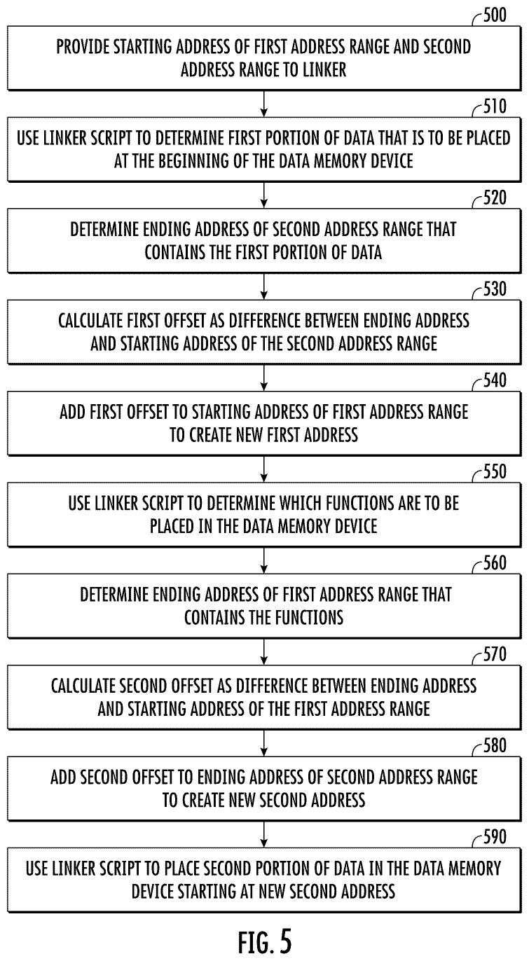

According to another embodiment, the instructions 41 are not placed at the starting address of the data memory device 40. In this case, the linker script needs to track more information such that the linker creates an appropriate executable file. FIG. 4 shows another layout of the data memory device 40 in which the instructions 41 are located within the data memory device 40 after some amount of data. While FIG. 4 shows the secure RAM and other information 49 as being disposed at the starting address, this is merely illustrative as any other data may be disposed at this address. Further, additional data, such as heap 42 and data buffers 44, is located after the instructions 41. FIG. 5 shows the operation of the linker and the linker script to create this memory layout.

First, as shown in Box 500, the linker is provided with the aliased address (0x3000000) and the non-aliased address (0x2000000) that each map to the start of the data memory device 40. These two addresses represent the starting address of the first address range and the second address range, respectively. Then, the linker script determines a first portion of data that is to be located at the starting address of the data memory device 40, as shown in Box 510. The linker then assigns this first portion of data the addresses starting at 0x2000000. Next, the linker script determines the ending address used for this first portion of data as shown in Box 520. The original starting address (0x2000000) is then subtracted from this ending address as shown in Box 530. This represents the amount of storage that is consumed by the first portion of data in the data memory device 40. The linker script then uses this value as a first offset, which is added to the starting address of the first address range, as shown in Box 540.

The linker will begin allocating space in the first address range starting at the new first address, or 0x3000000+offset1.

As shown in Box 550, the linker uses a linker script to determine which functions are to be placed in the data memory device 40. The linker script tracks the addresses that are assigned to the various functions that are being copied to the data memory device 40, which begins at 0x3000000+offset1. When all of the desired functions have been placed in the data memory device 40, the linker script then determines the ending address used for these functions as shown in Box 560. The new first address (0x3000000+offset1) is then subtracted from this ending address as shown in Box 570. This represents the amount of storage that is consumed by the instructions 41 in the data memory device 40. The linker script then uses this value as a second offset, which is added to the ending address of the second address range, as shown in Box 580. Thus, the linker will begin allocating space in the second address range starting at the new second address, which is 0x2000000+offset1+offset2, as shown in Box 590. In this way, although the linker may believe that addresses 0x2000000+offset1 through 0x2000000+offset1+offset2−1 are free, they are not used by the linker.

The present system has many advantages. First, by utilizing a linker script with these features, it is possible to access one memory device using two different address ranges without corruption of data. This may be useful when using processing units that use separate busses for instructions and data. Additionally, in this approach, only the exact amount of space that is required by the instructions 41 is allocated to the instructions. For example, in a simpler approach, one may simply assign a block in the data memory device 40 as the region where instructions 41 are stored. However, in certain embodiments, this may be wasteful, as the actual space needed by the instructions 41 may be less than that which was allocated. Conversely, this approach may be ineffective, as the amount of space needed by the instructions 41 may be greater than that which was allocated. Thus, this system and method allows the space consumed by the instructions 41 to be dynamically allocated.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. such Thus, other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method of creating an executable file using a linker script, comprising:
assigning a first address range and a second address range to a same physical memory device, such that a region of the physical memory device is accessible using addresses within the first address range and using addresses within the second address range;
allocating a first portion of the physical memory device to the first address range for storage of instructions, starting at a first starting address;
determining a size of the first portion, referred to as an offset;
adding the offset to a starting address of the second address range to define a new second address of the second address range;
allocating data in the physical memory device to the second address range starting at the new second address of the second address range; and
creating the executable file, which allocates instructions starting at the first starting address in the first address range and data starting at the new second address in the second address range.

2. (canceled)

3. The method of claim 1, wherein the linker script determines which functions are to be stored in the first portion of the physical memory device.

4. The method of claim 1, wherein the first address range is designated as read only.

5. The method of claim 1, wherein the second address range is designated as readable and writable.

6. A system comprising:
a processing unit;
a nonvolatile memory device; and
the physical memory device configured by executing executable file created using the method of claim 1;
wherein the processing unit uses the first address range to access instructions and the second address range to access data.

7. The system of claim 6, wherein the nonvolatile memory device contains instructions.

8. The system of claim 6, wherein the processing unit comprises separate buses for accessing instructions and data.

9. A method of creating an executable file using a linker script, comprising:
assigning a first address range and a second address range to a same physical memory device, such that a region of the physical memory device is accessible using addresses within the first address range and using addresses within the second address range;
allocating a first portion of the physical memory device to the second address range for storage of a first portion of data, starting at a second starting address;
determining a size of the first portion of data, referred to as a first offset;
adding the first offset to a starting address of the first address range to define a new first address of the first address range;
allocating a second portion of the physical memory device to the first address range for storage of instructions, starting at the new first address;
determining a size of the instructions, referred to as a second offset;
adding the second offset to an ending address of the first portion of data to define a new second address;
allocating a second portion of data to the second address range starting at the new second address of the second address range; and
creating the executable file, which allocates instructions starting at the new first address, a first portion of data starting at the second starting address and a second portion of data starting at the new second address.

10. (canceled)

11. The method of claim 9, wherein the linker script determines which functions are to be stored in the second portion of the physical memory device.

12. The method of claim 9, wherein the first address range is designated as read only.

13. The method of claim 9, wherein the second address range is designated as readable and writable.

14. A system comprising:
a processing unit;
a nonvolatile memory device; and
the physical memory device configured by executing the executable file created using the method of claim 9;
wherein the processing unit uses the first address range to access instructions and the second address range to access data.

15. The system of claim 14, wherein the nonvolatile memory device contains instructions.

16. The system of claim 14, wherein the processing unit comprises separate buses for accessing instructions and data.

17. The system of claim 14, wherein the first portion of data comprises secure data and other information and the second portion comprises data buffers.

18. The system of claim 7, wherein the processing unit copies instructions from the nonvolatile memory device to the region in the physical memory device by accessing the region using the second address range and executes the instructions that were copied into the region by accessing the region using the first address range.

19. The system of claim 14, wherein the processing unit copies instructions from the nonvolatile memory device to the region in the physical memory device by accessing the region using the second address range and executes the instructions that were copied into the region by accessing the region using the first address range.
